(19) United States
(12) Patent Application Publication
(10) Pub. No.: US 2013/0003843 A1
(43) Pub. Date: Jan. 3, 2013

(54) Motion Prediction Method

(75) Inventors: Xun Guo, Beijing City (CN); Jicheng An, Beijing (CA); Yu-Wen Huang, Taipei (TW); Shaw-Min Lei, Taipei (CN)

(73) Assignee: MEDIATEK SINGAPORE PTE. LTD., Ayer Rajah Crescent (SG)

(21) Appl. No.: 13/003,092

(22) PCT Filed: Dec. 6, 2010
(86) PCT No.: PCT/CN2010/079482

§ 371 Date: Jan. 7, 2011

Related U.S. Application Data
(60) Provisional application No. 61/313,178, filed on Mar. 12, 2010.
(60) Provisional application No. 61/348,311, filed on May 26, 2010.

(51) Int. Cl. H04N 7/32; H04N 7/50

(52) U.S. Cl. 375/240.16; 375/E07.125; 375/E07.256; 375/E07.226

(57) ABSTRACT

The invention provides a motion prediction method First, a coding unit (CU) of a current picture is processed, wherein the CU comprises at least a first prediction unit (PU) and a second PU. A second candidate set comprising a plurality of motion parameter candidates for the second PU is then determined, wherein at least a motion parameter candidate in the second candidate set is derive from a motion parameter predictor for a previously coded PU of the current picture, and the second candidate set is different from a first candidate set comprising a plurality of motion parameter candidates for the first PU. A motion parameter candidate is then selected from the second candidate set as a motion parameter predictor for the second PU. Finally, predicted samples are then generated from the motion parameter predictor of the second PU partition.

### CROSS REFERENCE TO RELATED APPLICATIONS

This application claims the benefit of U.S. Provisional Application No. 61/313,178, filed on Mar. 12, 2010, and U.S. Provisional Application No. 61/348,311, filed on May 26, 2010, the entirety of which are incorporated by reference herein.

### FIELD OF INVENTION

The invention relates to video processing, and more particularly to motion prediction of video data in video coding.

### BACKGROUND OF THE INVENTION

H.264/AVC is a video compression standard. The H.264 standard can provide good video quality at substantially lower bit rates than previous standards. The video compression process can be divided into 5 parts including inter-prediction/intra-prediction, transform/inverse-transform, quantization/inverse-quantization, loop filter, and entropy encoding. H.264 is used in various applications such as Blu-ray Disc, DVB broadcast, direct-broadcast satellite television service, cable television services, and real-time videoconferencing.

Skip mode and direct mode are introduced to improve previous H.264 standard, these two modes significantly reduce the bit-rate by coding a block without sending residual errors or motion vectors. In a direct mode, encoders exploit temporal correlation of adjacent pictures or spatial correlation of neighboring blocks to derive motion vectors. Decoders derive the motion vectors of the block coded with direct mode from other blocks already decoded. Referring to FIG. 1, a schematic diagram of motion prediction of a macroblock 100 according to a spatial direct mode of the H.264 standard is shown. The macroblock 100 is a 16×16 block comprising 16 4×4 blocks. According to the spatial direct mode, three neighboring blocks A, B, and C are used as reference for generating a motion parameter of the macroblock 100. If the neighboring block C does not exist, three neighboring blocks A, B, and D are used as reference for generating the motion parameter of the macroblock 100. The motion parameter of the macroblock 100 comprises a reference picture index and a motion vector for each prediction direction. As for generation of the reference picture index of the macroblock 100, a minimum reference picture index is selected from the reference picture indices of the neighboring blocks A, B, and C (or D), wherein the minimum reference picture index is determined to be the reference picture index of the macroblock 100. As for generation of the motion vector of the macro block 100, a medium motion vector is selected from the motion vectors of the neighboring blocks A, B, and C (or D), wherein the medium motion vector is determined to be the motion vector of the macroblock 100. In addition, a video encoder determines motion parameters including predictive motion vectors and reference indices in a unit of a macroblock. In other words, all blocks of a macroblock share only one motion parameter in the spatial direct mode. Each of the blocks within the same macroblock select either the motion vector determined for the macroblock or zero as its motion vector according to the motion vector of the temporal collocated block in a backward reference frame.

Referring to FIG. 2, a schematic diagram of motion prediction of a macroblock 212 according to a temporal direct mode of the H.264 standard is shown. Three frames 202, 204, and 206 are shown in FIG. 2. The current frame 202 is a B frame, the backward reference frame 204 is a P frame, and the forward reference frame is an I frame or a P frame. A collocated block of the current block 212 in the backward reference frame 204 has a motion vector MV_{D} in reference to the forward reference frame 206. A timing difference between the backward reference frame 204 and the forward reference frame 206 is TRₚ, and a timing difference between the current frame 202 and the forward reference frame 206 is TR_{b}. A motion vector MV_{F} of the current block 212 in reference to the forward reference frame 206 is then calculated according to the following algorithm:

$${MV}_{F} = \frac{{TR}_{b}}{{TR}_{p}} \times {MV}_{D} ;$$

Similarly, a motion vector MVB of the current block 212 in reference to the backward reference frame 204 is then calculated according to the following algorithm:

$${MV}_{B} = \frac{{TR}_{b} - {TR}_{p}}{{TR}_{p}} \times {MV}_{D} .$$

### SUMMARY OF THE INVENTION

The invention provides a motion prediction method. First, a coding unit (CU) of a current picture is processed, wherein the CU comprises at least a first prediction unit (PU) and a second PU. A second candidate set comprising a plurality of motion parameter candidates for the second PU is then determined, wherein at least a motion parameter candidate in the second candidate set is derived from a motion parameter predictor for a previously coded PU of the current picture, and the second candidate set may be different from a first candidate set comprising a plurality of motion parameter candidates for the first PU. A motion parameter candidate is then selected from the second candidate set as a motion parameter predictor for the second PU. Finally, predicted samples are then generated from the motion parameter predictor of the second PU partition.

The invention provides a motion derivation method. First, a current unit is received, wherein the current unit is smaller than a slice. A motion prediction mode for processing the current unit is then selected from a spatial direct mode and a temporal direct mode according to a flag. When the spatial direct mode is selected to be the motion prediction mode, a motion parameter of the current unit is generated according to the spatial direct mode. When the temporal direct mode is selected to be the motion prediction mode, the motion parameter of the current unit is generated according to the temporal direct mode.

The invention provides a motion prediction method. First, a coding unit (CU) of a current picture is processed, wherein the CU comprises a plurality of prediction unit (PU). The PUs are then divided into a plurality of groups according to a target direction, wherein each of the groups comprises the PUs aligned in the target direction. A plurality of previously coded units respectively corresponding to the groups are then determined, wherein the previously coded units are aligned with the PUs of the corresponding group in the target direction. Predicted samples of the PUs of the groups are then generated from motion parameters of the corresponding previously coded units.

A detailed description is given in the following embodiments with reference to the accompanying drawings.

### BRIEF DESCRIPTION OF THE DRAWINGS

The invention can be more fully understood by reading the subsequent detailed description and examples with references made to the accompanying drawings, wherein:

FIG. 1 is a schematic diagram illustrating motion prediction of a macroblock in a spatial direct mode;

FIG. 2 is a schematic diagram illustrating motion prediction of a macroblock in a temporal direct mode;

FIG. 3 is a block diagram of a video encoder according to an embodiment of the invention;

FIG. 4 is a block diagram of a video decoder according to an embodiment of the invention;

FIG. 5A shows an example of motion parameter candidates in a candidate set of the first prediction unit;

FIG. 5B shows another example of motion parameter candidates in the candidate set of the tenth prediction unit;

FIG. 6A is a flowchart of a motion prediction method in a spatial direct mode for a video encoder according to an embodiment of the invention;

FIG. 6B is a flowchart of a motion prediction method in a spatial direct mode for a video decoder according to an embodiment of the invention;

FIG. 7A is a flowchart of a motion prediction method for a video encoder according to an embodiment of the invention;

FIG. 7B is a flowchart of a motion prediction method for a video decoder according to an embodiment of the invention;

FIG. 8A shows neighboring units of a macroblock;

FIG. 8B is a schematic diagram illustrating generation of motion parameters according to a horizontal direct mode;

FIG. 8C is a schematic diagram illustrating generation of motion parameters according to a vertical direct mode;

FIG. 8D is a schematic diagram illustrating generation of motion parameters according to a diagonal down-left direct mode; and

FIG. 8E is a schematic diagram illustrating generation of motion parameters according to a diagonal down-right direct mode;

FIG. 9 is a flowchart of a motion prediction method according to the invention.

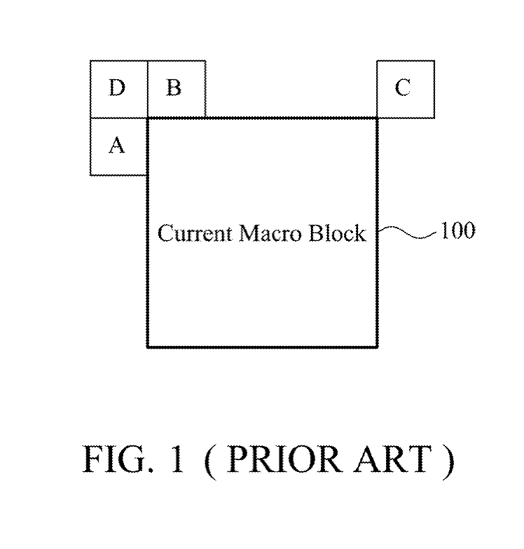

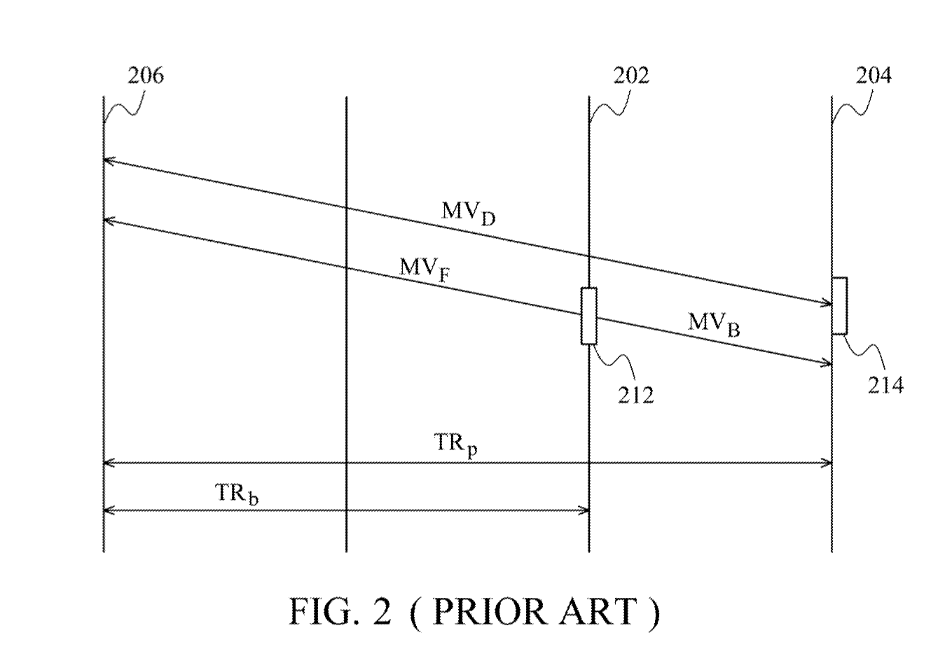

### DETAILED DESCRIPTION

The following description is of the best-contemplated mode of carrying out the invention. This description is made for the purpose of illustrating the general principles of the invention and should not be taken in a limiting sense. The scope of the invention is best determined by reference to the appended claims.

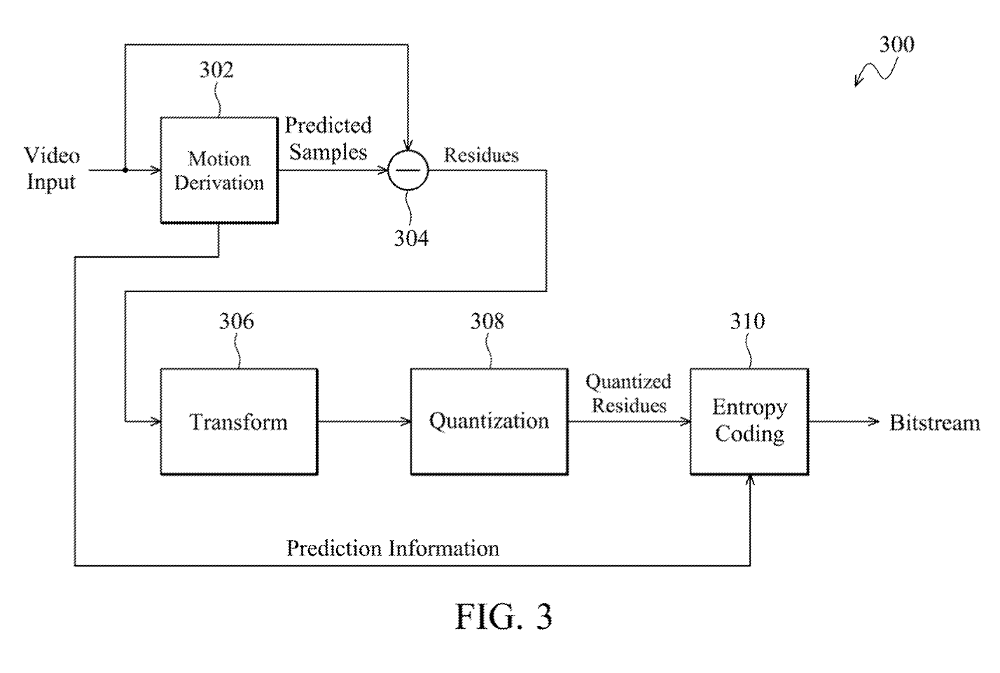

Referring to FIG. 3, a block diagram of a video encoder 300 according to an embodiment is shown. The video encoder 300 comprises a motion prediction module 302, a subtraction module 304, a transform module 306, a quantization module 308, and an entropy coding module 310. The video encoder 300 receives a video input and generates a bitstream as an output. The motion prediction module 302 performs motion prediction on the video input to generate predicted samples and prediction information. The subtraction module 304 then subtracts the predicted samples from the video input to obtain residues, thereby reducing a video data amount from that of the video input to that of the residues. The residues are then sequentially sent to the transform module 306 and the quantization module 308. The transform module 306 performs a discrete cosine transform (DCT) on the residues to obtain transformed residues. The quantization nodule 308 then quantizes the transformed residues to obtain quantized residues. The entropy coding module 310 then performs entropy coding on the quantized residues and prediction information to obtain a bitstream as a video output.

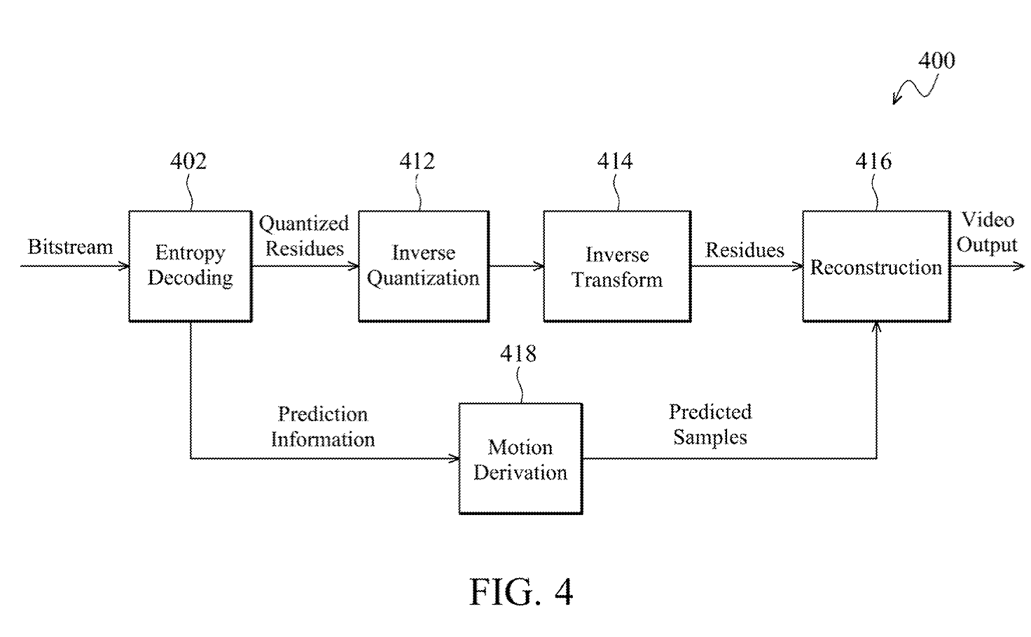

Referring to FIG. 4, a block diagram of a video decoder 400 according to an embodiment is shown. The video decoder 400 comprises an entropy decoding module 402, an inverse quantization module 412, an inverse transform module 414, a reconstruction module 416, and a motion prediction module 418. The video decoder 400 receives an input bitstream and outputs a video output. The entropy decoding module 402 decodes the input bitstream to obtain quantized residues and prediction information. The prediction information is sent to the motion prediction module 418. The motion prediction module 418 generates predicted samples according to the prediction information. The quantized residues are sequentially sent to the inverse quantization module 412 and the inverse transform module 414. The inverse quantization module 412 performs inverse quantization to convert the quantized residues to transformed residues. The inverse transform module 414 performs an inverse discrete cosine transform (IDCT) on the transformed residues to convert the transformed residues to residues. The reconstruction module 416 then reconstructs a video output according to the residues output from the inverse transform module 414 and the predicted samples output from the motion prediction module 418.

According to a newest standard for motion prediction, a coding unit is defined to comprise a plurality of prediction units. Each prediction unit has its own motion vector and reference index. The phrases in the following illustration of the invention are based on the aforementioned definition.

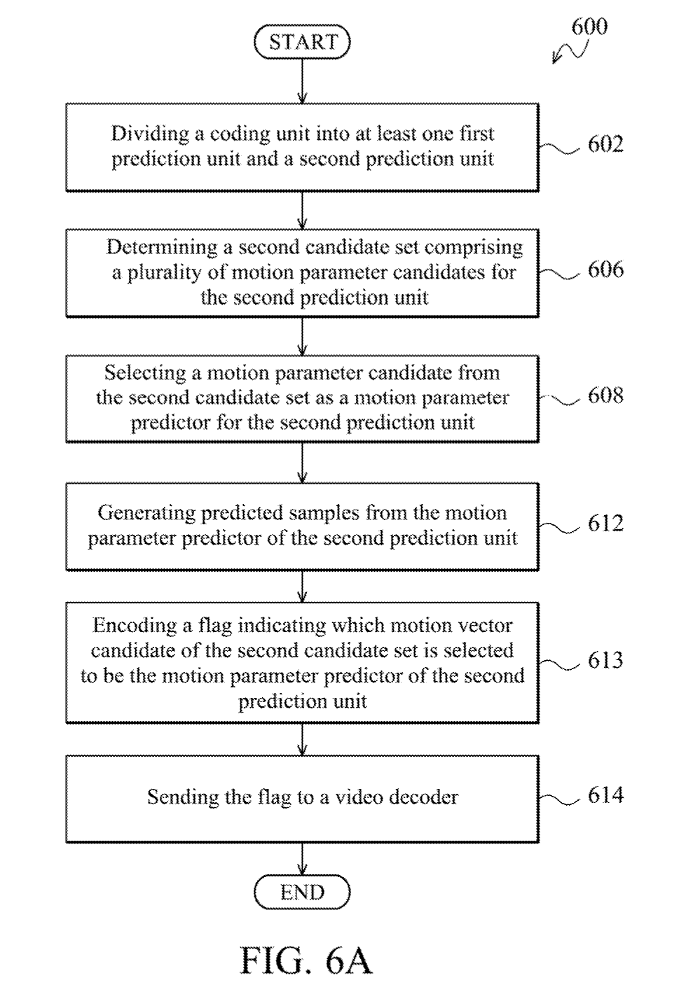

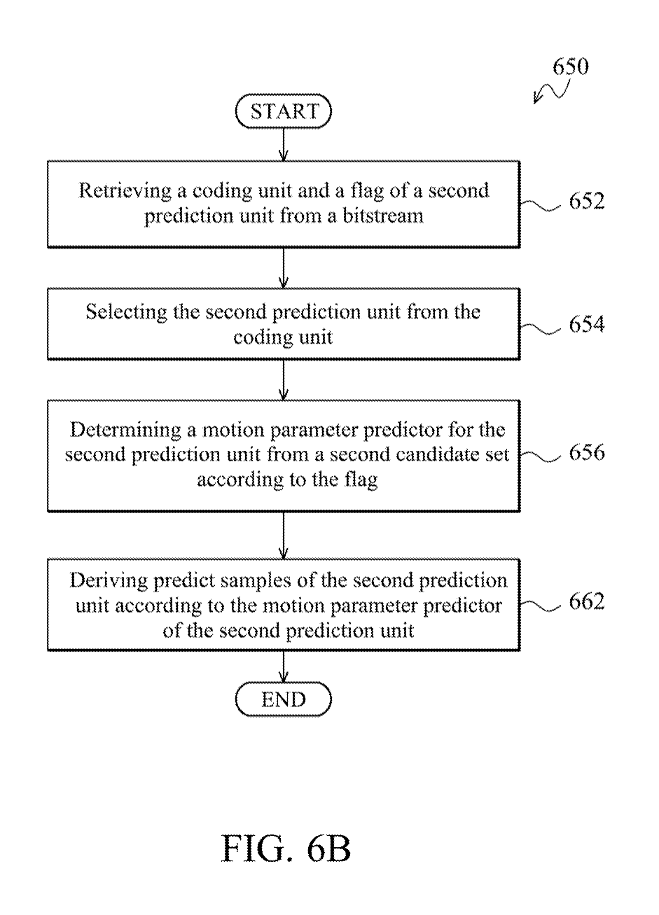

The motion prediction module 302 of the invention generates motion parameters in a unit of a prediction unit. Referring to FIG. 6A, a flowchart of a motion derivation method 600 in a spatial direct mode for a video encoder according to an embodiment of the invention is shown. First, the video encoder 300 receives a video input and retrieves a coding unit from the video input. In this embodiment, the coding unit is a macroblock of size 16×16 pixels; in some other embodiments, the coding unit is an extended macroblock of size 32×32 or 64×64 pixels. The coding unit can be further divided into a plurality of prediction unit (step 602). In this embodiment, the coding unit comprises at least one first prediction unit and a second prediction unit. In this embodiment, the prediction units are 4×4 blocks. The motion prediction module 302 then determines a second candidate set comprising a plurality of motion parameter candidates for the second prediction unit (step 606), wherein at least a motion parameter candidate in the second candidate set is derived from a motion parameter predictor for a previously coded PU of the current picture, and the second candidate set is different from a first candidate set comprising a plurality of motion parameter candidates for the first PU. In one embodiment, a motion parameter candidate comprises one or more forward motion vectors, one or more backward motion vectors, one or more reference picture indices, or combination of one or more forward/backward motion vectors and one or more reference picture indices. In one embodiment, at least one of the motion parameter candidates in the second candidate set is a motion parameter predictor for a PU within the same CU as the second PU. In another embodiment, at least a motion parameter candidate in the second candidate set is the motion parameter predictor for a PU which is neighbored to the second PU. The motion derivation module 302 then selects a motion parameter candidate of the second prediction unit from the motion parameter candidates of the second candidate set as a motion parameter predictor for the second prediction unit (step 608).

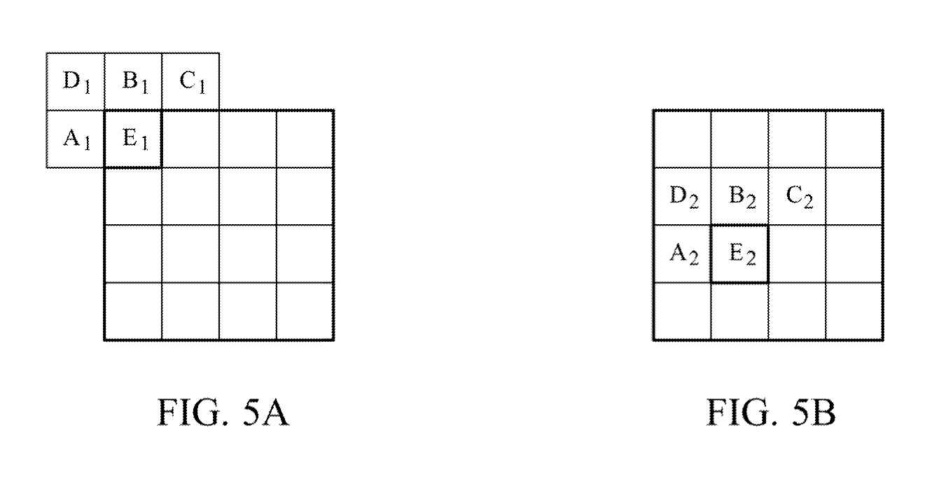

Referring to FIG. 5A, an example of motion parameter candidates in the second candidate set of a first prediction unit E₁ is shown. Assume that a block E₁ is a first prediction unit. In one embodiment, the second candidate set of the first prediction unit E₁ comprises a left block A₁ on the left side of E₁, an upper block B₁ on the upper side of E₁, and an upper-right block C₁ on an upper-right direction of E₁. If the upper-right block C₁ does not exist, the second candidate set of E₁ further comprises an upper-left block D₁ on an upper-left direction of E₁. The motion derivation module 302 selects one from the second candidate set as a motion parameter candidate for E₁. In one embodiment, the motion derivation module 302 compares the MVs of the motion parameter candidates A₁, B₁, and C₁, selects a medium motion vector, and determines a final MV predictor to be the medium motion vector or zero according to temporal information. For example, the final MV predictor is set to zero when the MV of a temporal collocated prediction unit of E₁ is less than a threshold. Referring to FIG. 5B, an example of motion parameter candidates in the second candidate set of the tenth prediction unit E₂ is shown. The second candidate set of E₂ therefore comprises a left block A₂ on the left side of E₂, an upper block B₂ on the upper side of E₂, and an upper-right block C₂ on an upper-right direction of E₂. If the upper-right block C₂ does not exist, the second candidate set of E₂ further comprises an upper-left block D₂ on an upper-left direction of E₂. In this example, all motion parameter candidates of the second candidate set of E₂ are within the same coding unit as E₂.

In this embodiment, the motion derivation module 302 determines the final motion parameter predictor of the prediction unit at step 606, however, in some other embodiments, the motion derivation module 302 determines a reference picture index from a plurality reference picture index candidates, or a motion vector and a reference picture index from a plurality of motion vector candidates and reference picture index candidates in step 606. In the following description, the term “motion parameter” is used to refer to a motion vector, a reference picture index, or a combination of a motion vector and a reference picture index.

The motion derivation module 302 then derives predicted samples of the second prediction unit from the motion parameter predictor of the second prediction unit (step 612) and delivers the predicted samples to the subtraction module 304 to generate residues. The residues are transformed, quantized, and entropy coded to generate bitstream. In one embodiment, the motion derivation module 302 further encodes a flag indicating which MV candidate has been selected to be the motion parameter predictor for the second prediction unit (step 613) and outputs the flag to the entropy coding module 310. The entropy coding module 310 then encodes the flag and sends the flag to a video decoder (step 614). The method of inserting a flag or encoding an index in the bitstream to indicate the final motion parameter predictor is called explicit MV selection. Implicit MV selection on the other hand does not require a flag or index to indicate which one of the MV candidates is chosen as the final motion parameter predictor, by setting a rule between encoders and decoders, the decoders may determine the final motion parameter predictor using the same way as the encoder.

Referring to FIG. 6B, a flowchart of a motion prediction method 650 in a spatial direct mode for a video decoder according to an embodiment of the invention is shown. First, the video decoder 400 receives a bitstream and the entropy decoding module 402 retrieves a coding unit and a flag corresponding to a second prediction unit from the bitstream (step 652). The motion derivation module 418 selects the second prediction unit from the coding unit (step 654), and determines the final motion parameter predictor from a plurality of motion parameter candidates of a second candidate set according to the flag (step 656). The second candidate set comprises motion parameters of neighboring partitions close to the second prediction unit. In one embodiment, the motion parameter of the second prediction unit comprises a motion vector and a reference picture index. The motion prediction module 418 then derives predicted samples of the second prediction unit according to the motion parameter predictor (step 662) and delivers the predicted samples to the reconstruction module 416. In another embodiment, when implicit MV selection is implemented, the decoder derives motion parameters for prediction units coded in spatial direct mode using the same way as the corresponding encoder. For example, the motion derivation module 418 identifies a plurality of neighboring partitionts (for example, A₁, B₁, and C₁ in FIG. 5 or A₂, B₂, and C₂ in FIG. 6) for a prediction unit, and determines the motion parameter of the prediction unit to be the medium of the motion parameters of the identified neighboring partitions, or using other rules.

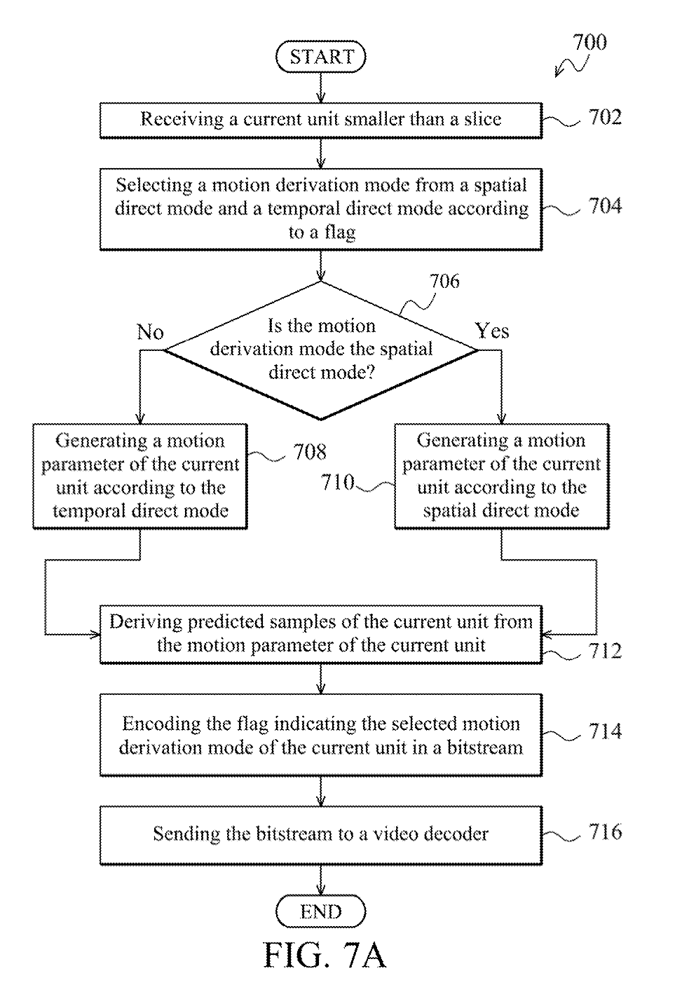

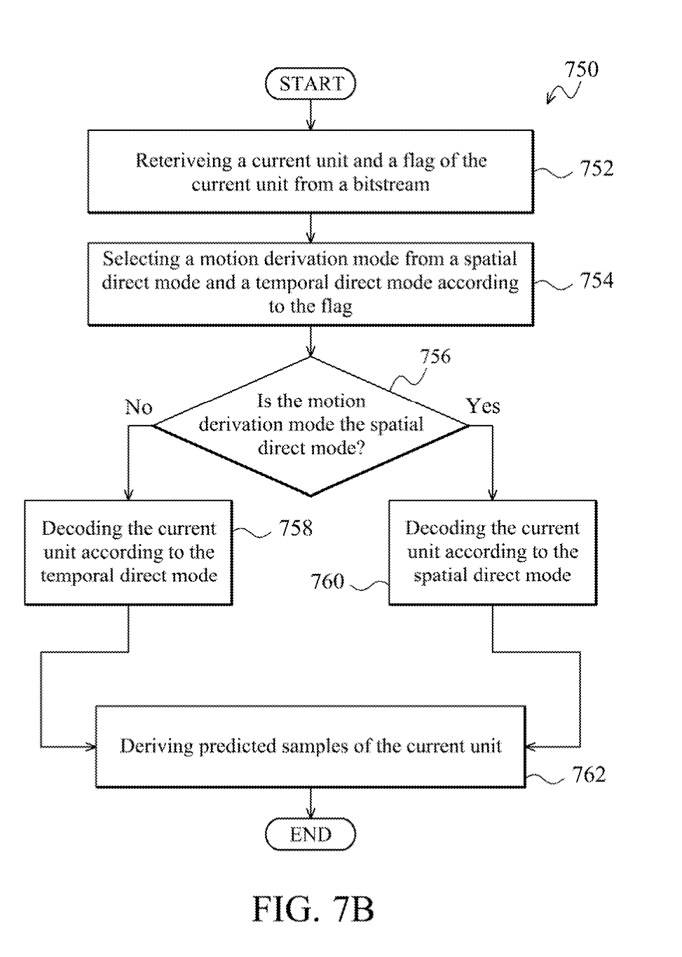

A conventional motion derivation module of a video encoder changes a direct mode between a spatial direct mode and a temporal direct mode at a slice level. The motion derivation module 302 of an embodiment of the invention, however, can switch a direct mode between a spatial direct mode and a temporal direct mode in a prediction unit level, for example in the extended macroblock level, macroblock level, or block level. Referring to FIG. 7A, a flowchart of a motion derivation method 700 for a video encoder according to an embodiment of the invention is shown. First, the video encoder 300 receives a video input, and retrieves a current unit from the video input (step 702), wherein the current unit is smaller than a slice. In one embodiment, the current unit is a prediction unit which is a unit for motion prediction. The motion derivation module 302 selects a motion prediction mode to process the current unit from a spatial direct mode and a temporal direct mode when processing the current unit with direct mode (step 704). In one embodiment, the motion derivation module 302 selects the motion prediction mode according to a rate-distortion optimization (RDO) method, and generates a flag indicating the selected motion prediction mode.

When the selected motion derivation mode is the spatial direct mode (step 706), the motion derivation module 302 generates a motion parameter of the current unit according to the spatial direct mode (step 710). Otherwise, when the selected motion derivation mode is the temporal direct mode (step 708), the motion derivation module 302 generates a motion parameter of the current unit according to the temporal direct mode (step 708). The motion derivation module 302 then derives predicted samples of the current unit from the motion parameter of the current unit (step 712), and delivers the predicted samples to the subtraction module 304. The motion derivation module 302 also encodes the flag indicating the selected motion derivation mode of the current unit in a bitstream (step 714), and sends the bitstream to the entropy coding module 310. In one embodiment, additional 1 bit is sent to indicate temporal or spatial mode when MB type is 0, regardless coded block pattern (cbp) is 0 (B_skip) or not (B_direct). The entropy coding module 310 then encodes the bitstream and sends the bitstream to a video decoder. (step 716)

Referring to FIG. 7B, a flowchart of a motion prediction method 750 for a video decoder according to an embodiment of the invention is shown. First, the video decoder 400 retrieves a current unit and a flag corresponding to the current unit from a bitstream (step 752). The flag comprises motion information indicating whether the motion derivation mode of the current unit is a spatial direct mode or a temporal direct mode, and the motion derivation module selects a motion derivation mode from a spatial direct mode and a temporal direct mode according to the flag (step 754). When the motion derivation mode is the spatial direct mode (step 756), the motion derivation module 418 decodes the current unit according to the spatial direct mode (step 760). Otherwise, when the motion derivation mode is the temporal direct mode (step 758), the motion derivation module 418 decodes the current unit according to the temporal direct mode (step 758). The motion derivation module 418 then derives predicted samples of the current unit according to the motion parameter (step 762), and delivers the predicted samples to the reconstruction module 416.

In some embodiments, motion parameter candidates for a prediction unit comprise at least one motion parameter predicted from spatial direction and at least one motion parameter predicted from temporal direction. A flag or index can be sent or coded in the bitstream to indicate which motion parameter is used. For example, a flag is sent to indicate whether the final motion parameter is derived from spatial direction or temporal direction.

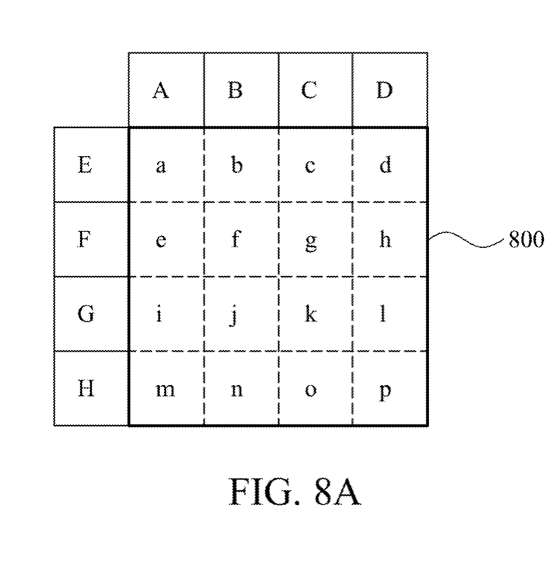

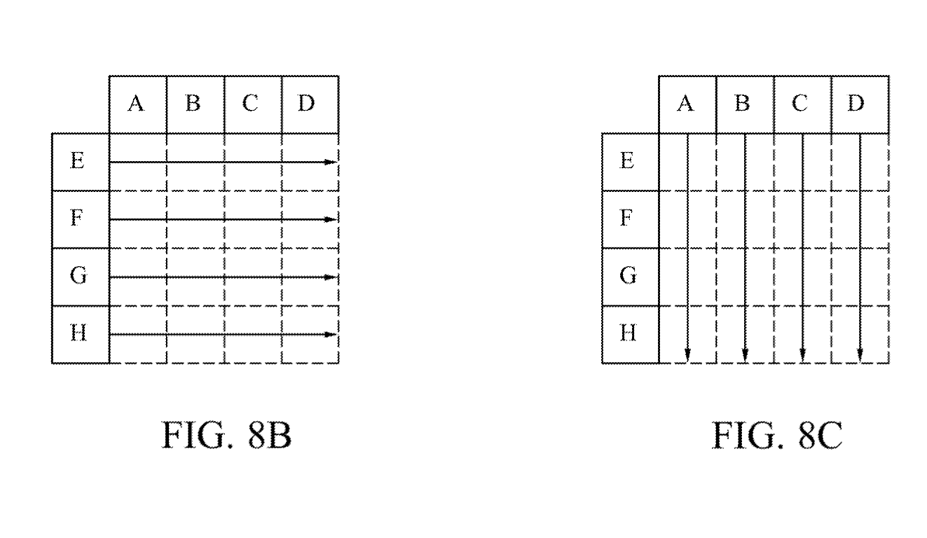

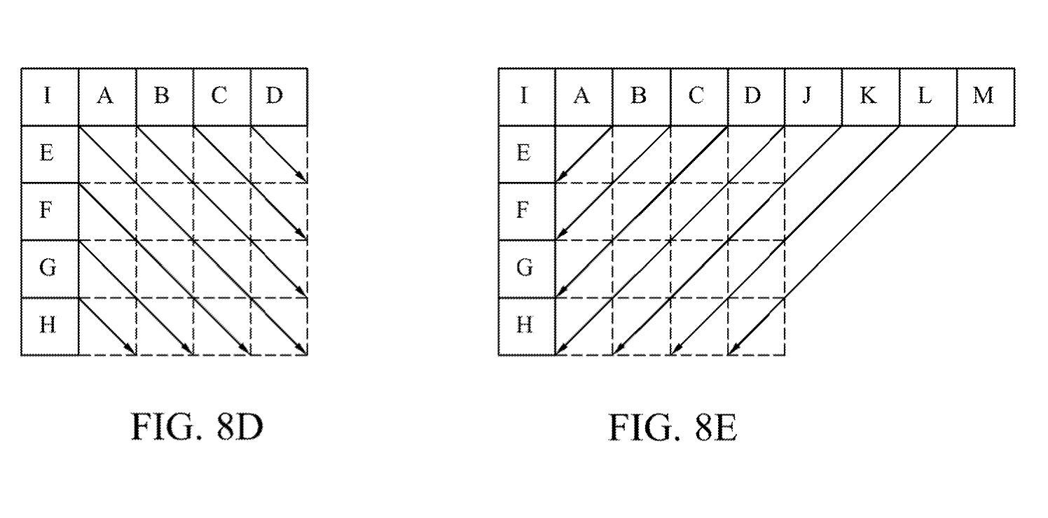

Referring to FIG. 8A of the invention, previously coded blocks A to H of a macroblock 800 is shown to demonstrate embodiments of spatial directional direct modes. The macroblock 800 comprises 16 4×4 blocks a˜p. The macroblock 800 also has four neighboring 4×4 blocks A, B, C, and D on an upper side of the macroblock 800 and four neighboring 4×4 blocks E, F, G, and H on a left side of the macroblock 800. Four exemplary spatial directional direct modes are illustrated in FIGS. 8B to 8E. One flag can be sent at the coding unit level to specify which spatial direction direct mode is used. Referring to FIG. 8B, a schematic diagram of generation of motion parameters according to a horizontal direct mode is shown. According to the horizontal direct mode, a block in the macroblock 800 has a motion parameter equal to that of a previously coded block located on the same row as that of the block. For example, because the blocks a, b, c, and d and the previously coded block E are on the same row, the motion parameters of the blocks a, b, c, and d are all the same as that of the previously coded block E. Similarly, the motion parameters of the blocks e, f, g, and h are all the same as that of the previously coded block F, the motion parameters of the blocks i, j, k, and l are all the same as that of the previously coded block G, and the motion parameters of the blocks m, n, o, and p are all the same as that of the previously coded block H.

Referring to FIG. 8C, a schematic diagram of generation of motion parameters according to a vertical direct mode is shown. According to the vertical direct mode, a block of the macro block 800 has a motion parameter equal to that of a previously coded block located on the same column as that of the block. For example, because the blocks a, e, i, and m and the previously coded block A are on the same column, the motion parameters of the blocks a, e, i, and m are all the same as that of the previously coded block A. Similarly, the motion parameters of the blocks b, f, j, and n are all the same as that of the previously coded block B, the motion parameters of the blocks c, g, k, and o are all the same as that of the previously coded block C, and the motion parameters of the blocks d, h, l, and p are all the same as that of the previously coded block D.

Referring to FIG. 8D, a schematic diagram of generation of motion parameters according to a diagonal down-left direct mode is shown. According to the diagonal down-left direct mode, a block of the macro block 800 has a motion parameter equal to that of a previously coded block located on the upper left direction of the block. For example, the motion parameters of the blocks a, f, k, and p are all the same as that of the previously coded block I. Similarly, the motion parameters of the blocks b, g, and 1 are all the same as that of the previously coded block A, the motion parameters of the blocks e, j, and o are all the same as that of the previously coded block E, the motion parameters of the blocks c and h are the same as that of the previously coded block B, the motion parameters of the blocks i and n are the same as that of the previously coded block F, and the motion parameters of the blocks d and m are respectively the same as those of the previously coded blocks C and G.

Referring to FIG. 8E, a schematic diagram of generation of motion parameters according to a diagonal down-right direct mode is shown. According to the diagonal down-right direct mode, a block of the macro block 800 has a motion parameter equal to that of a previously coded block located on the upper right direction of the block. For example, the motion parameters of the blocks d, g, j, and m are all the same as that of the previously coded block J. Similarly, the motion parameters of the blocks c, f, and i are all the same as that of the previously coded block D, the motion parameters of the blocks h, k, and n are all the same as that of the previously coded block K, the motion parameters of the blocks b and e are the same as that of the previously coded block C, the motion parameters of the blocks l and o are the same as that of the previously coded block L, and the motion parameters of the blocks a and p are respectively the same as those of the previously coded blocks B and M.

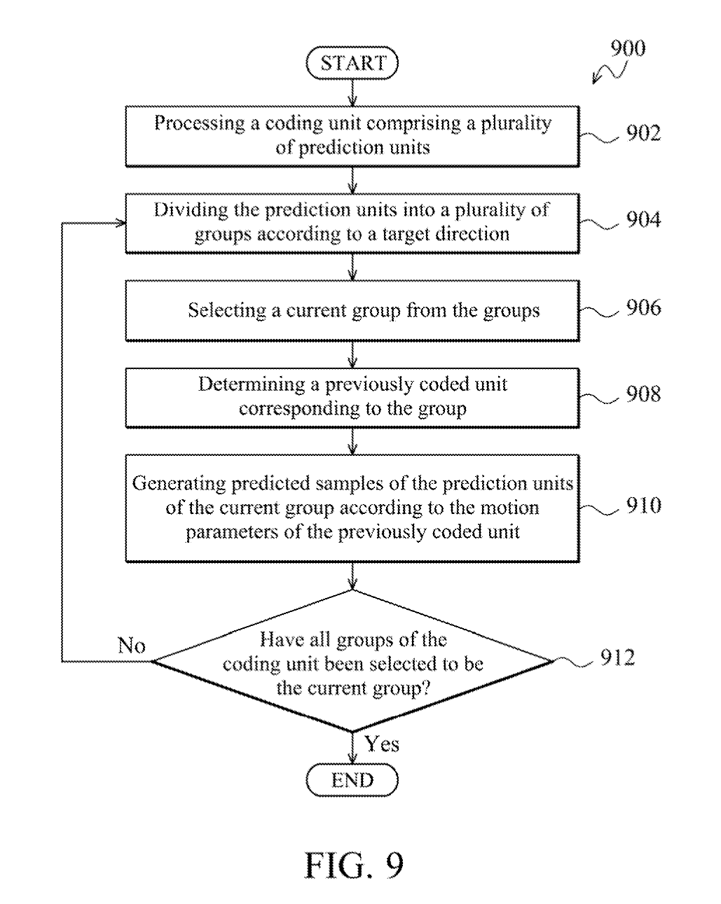

Referring to FIG. 9, a flowchart of a motion prediction method 900 according to the invention is shown. The embodiments of motion prediction shown in FIGS. 8A-8E draws a conclusion to the method 900. First, a coding unit comprising a plurality of prediction unit is processed (step 902). In one embodiment, the coding unit is a macro block. The prediction unit are then divided into a plurality of groups according to a target direction (step 904), wherein each of the groups comprises the prediction units aligned in the target direction. For example, when the target direction is a horizontal direction, the prediction units on the same row of the coding unit forms a group, as shown in FIG. 8B. When the target direction is a vertical direction, the prediction units on the same column of the coding unit forms a group, as shown in FIG. 8C. When the target direction is a down-right direction, the prediction units on the same down-right diagonal line of the coding unit forms a group, as shown in FIG. 8D. When the target direction is a down-left direction, the prediction units on the same down-left diagonal line of the coding unit forms a group, as shown in FIG. 8E.

A current group is then selected from the groups (step 906). A previously coded unit corresponding to the current group is then determined (step 908), and predicted samples of the prediction units of the current group are generated according to the motion parameter of the previously coded unit (step 910). For example, when the target direction is a horizontal direction, the motion parameters of the prediction units on a specific row of the coding unit is determined to be the motion parameter of the previously coded unit on a left side of the group, as shown in FIG. 8B. Similarly, when the target direction is a vertical direction, the motion parameters of the prediction units on a specific column of the coding unit is determined to be the motion parameter of the previously coded unit on an upper side of the group, as shown in FIG. 8C. Whether all groups have been selected to be the current group is determined (step 912). If not, steps 906˜910 are repeated. If so, the motion parameters of all prediction units of the coding unit have been generated.

While the invention has been described by way of example and in terms of preferred embodiment, it is to be understood that the invention is not limited thereto. For example, the proposed direct modes can be used in coding unit level, slice level, or other area-based level, and the proposed direct modes can be used in B slice or P slice. To the contrary, it is intended to cover various modifications and similar arrangements (as would be apparent to those skilled in the art). Therefore, the scope of the appended claims should be accorded the broadest interpretation so as to encompass all such modifications and similar arrangements.

1. A motion prediction method, comprising:
processing a coding unit (CU) of a current picture, wherein the CU comprises at least a first prediction unit (PU) and a second PU;
determining a second candidate set comprising a plurality of motion parameter candidates for the second PU, wherein at least a motion parameter candidate in the second candidate set is derived from a motion parameter predictor for a previously coded PU of the current picture, and the second candidate set is different from a first candidate set comprising a plurality of motion parameter candidates for the first PU;
selecting a motion parameter candidate from the second candidate set as a motion parameter predictor for the second PU; and
generating predicted samples from the motion parameter predictor of the second PU.

2. The motion prediction method as claimed in claim 1, wherein at least one of the motion parameter candidates in the second candidate set is a motion parameter predictor for a PU within the same CU as the second PU.

3. The motion prediction method as claimed in claim 1, wherein each of the motion parameter candidates comprises a motion vector, a reference picture index, or a combination of a motion vector and a reference picture index.

4. The motion prediction method as claimed in claim 1, wherein at least a motion parameter candidate in the second candidate set is the motion parameter predictor for a PU which is neighbored to the second PU.

5. The motion prediction method as claimed in claim 1, wherein the motion parameter candidates in the second candidate set comprises motion vectors, and selection of the motion parameter predictor for the second PU comprises:
determining a medium motion vector from the motion vectors in the second candidate set; and
determining the medium motion vector candidate to be the motion parameter predictor for the second PU.

6. The motion prediction method as claimed in claim 5, wherein the motion vectors in the second candidate set are motion vector predictor for neighboring PUs, the neighboring PUs comprise a left block on a left side of the second PU, an upper block on the upper side of the second PU, and an upper-right block on the upper-right direction of the second PU or an upper-left block on the upper-left direction of the second PU.

7. The motion prediction method as claimed in claim 1, wherein the coding unit (CU) is a leaf CU, and the PUs are 4×4 blocks.

8. The motion prediction method as claimed in claim 1, wherein the motion prediction method is used in an encoding process for encoding the current picture into a bitstream.

9. The motion prediction method as claimed in claim 8, further comprising inserting a flag in the bitstream to indicate the motion parameter predictor selected for the second PU.

10. The motion prediction method as claimed in claim 1, wherein the motion prediction method is used in a decoding process for decoding the current picture from a bitstream.

11. The motion prediction method as claimed in claim 10, wherein the motion parameter predictor for the second PU is selected based on a flag retrieved from the bitstream.

12. A video coder, receiving a video input, wherein a coding unit (CU) of a current picture of the video input comprises at least a first prediction unit (PU) and a second PU, the video coder comprising:
a motion derivation module, processing the coding unit (CU) of the current picture, determining a second candidate set comprising a plurality of motion parameter candidates for the second PU, selecting a motion parameter candidate from the second candidate set as a motion parameter predictor for the second PU, and generating predicted samples from the motion parameter predictor of the second PU;
wherein at least a motion parameter candidate in the second candidate set is derived from a motion parameter predictor for a first PU of the current picture, and the second candidate set is different from a first candidate set comprising a plurality of motion parameter candidates for the first PU.

13. The video coder as claimed in claim 12 (encoder, FIG. 3), wherein the video coder further comprises:
a subtractor, subtracting the predicted samples from the video input to obtain a plurality of residues;
a transform module, performing a discrete cosine transformation (DCT) on the residues to obtain transformed residues;
a quantization module, quantizing the transformed residues to obtain quantized residues; and
an entropy coding module, performing entropy coding on the quantized residues to obtain a bitstream.

14. The video coder as claimed in claim 12 (decoder, FIG. 4), wherein the video coder further comprises:
an entropy decoding module, decoding an input bitstream to obtain quantized residues and decodes the input bitstream to obtain quantized residues and prediction information, wherein the prediction information is sent to the motion prediction module as the video input;
an inverse quantization module, performing inverse quantization to convert the quantized residues to transformed residues;
an inverse transform module, performing an inverse discrete cosine transform (IDCT) on the transformed residues to convert the transformed residues to a plurality of residues; and
a reconstruction module, reconstructing a video output according to the residues output from the inverse transform module and the predicted samples generated by the motion derivation module.

15. The video coder as claimed in claim 12, wherein at least one of the motion parameter candidates in the second candidate set is a motion parameter predictor for a PU within the same CU as the second PU.

16. The video coder as claimed in claim 12, wherein each of the motion parameter candidates comprises a motion vector, a reference picture index, or a combination of a motion vector and a reference picture index.

17. The video coder as claimed in claim 12, wherein the motion derivation module further generates a flag to indicate the motion parameter predictor selected for the second PU.

18. A motion prediction method, comprising:
receiving a current unit, wherein the current unit is smaller than a slice;
selecting a motion derivation mode for processing the current unit from a spatial direct mode and a temporal direct mode according to a flag;
when the spatial direct mode is selected to be the motion derivation mode, generating a motion parameter of the current unit according to the spatial direct mode; and
when the temporal direct mode is selected to be the motion derivation mode, generating the motion parameter of the current unit according to the temporal direct mode.

19. The motion prediction method as claimed in claim 18, wherein the motion derivation mode is selected according to a rate-distortion optimization method, and the flag is inserted in a bitstream to indicate the selected motion prediction mode.

20. The motion prediction method as claimed in claim 19, wherein the flag is entropy coded in the bitstream.

21. The motion prediction method as claimed in claim 18, wherein the current unit is a coding unit, or a prediction unit.

22. The motion prediction method as claimed in claim 18, further comprising retrieving the current unit and the flag from a bitstream and decoding the current unit according to the selected motion derivation mode.

23. The motion prediction method as claimed in claim 18, wherein the motion parameter of the current unit is selected from a plurality of motion parameter candidates predicted from spatial direction.

24. The motion prediction method as claimed in claim 18, wherein the motion parameter of the current unit is selected from a plurality of motion parameter candidates predicted from temporal direction.

25. A video coder, receiving a video input comprising a current unit, wherein the video coder comprising:
a motion derivation module, receiving the current unit which is smaller than a slice, selecting a motion prediction mode for processing the current unit from a spatial direct mode and a temporal direct mode according to a flag, generating a motion parameter of the current unit according to the spatial direct mode when the spatial direct mode is selected to be the motion derivation mode, and generating the motion parameter of the current unit according to the temporal direct mode when the temporal direct mode is selected to be the motion derivation mode.

26. The video coder as claimed in claim 25 (encoder, FIG. 3), wherein the video coder further comprises:
a subtractor, subtracting the predicted samples from the video input to obtain a plurality of residues;
a transform module, performing a discrete cosine transform (DCT) on the residues to obtain transformed residues;
a quantization module, quantizing the transformed residues to obtain quantized residues; and
an entropy coding module, performing entropy coding on the quantized residues to obtain a bitstream.

27. The video coder as claimed in claim 25 (decoder, FIG. 4), wherein the video coder further comprises:
an entropy decoding module, decoding an input bitstream to obtain quantized residues and decodes the input bitstream to obtain quantized residues and prediction information, wherein the prediction information is sent to the motion derivation module as the video input;
an inverse quantization module, performing inverse quantization to convert the quantized residues to transformed residues;
an inverse transform module, performing an inverse discrete cosine transform (IDCT) on the transformed residues to convert the transformed residues to a plurality of residues; and
a reconstruction module, reconstructing a video output according to the residues output from the inverse transform module and the predicted samples generated by the motion prediction module.

28. The video coder as claimed in claim 25, wherein the motion derivation mode is selected according to a rate-distortion optimization method, and the flag is inserted in a bitstream to indicate the selected motion derivation mode.

29. The video coder as claimed in claim 28, wherein the flag is entropy coded in the bitstream.

30. The video coder as claimed in claim 25, wherein the current unit is a coding unit, or a prediction unit.

31. The video coder as claimed in claim 25, wherein the motion parameter of the current unit is selected from a plurality of motion parameter candidates predicted from spatial direction.

32. The video coder as claimed in claim 25, wherein the motion parameter of the current unit is selected from a plurality of motion parameter candidates predicted from temporal direction.

33. A motion prediction method, comprising: (spatial direct mode of FIG. 8) processing a coding unit (CU) of a current picture, wherein the CU comprises a plurality of prediction unit (PU)s;
dividing the PUs into a plurality of groups according to a target direction, wherein each of the groups comprises the PUs aligned in the target direction;
determining a plurality of previously coded units respectively corresponding to the groups, wherein the previously coded units are aligned with the PUs of the corresponding group in the target direction; and
generating predicted samples of the PUs of the groups from motion parameters of the corresponding previously coded units.

34. The motion prediction method as claimed in claim 33, wherein the target direction is a horizontal direction, each of the groups comprises the PUs on the same row of the CU, and the corresponding previously coded units are on a left side of the CU.

35. The motion prediction method as claimed in claim 33, wherein the target direction is a vertical direction, each of the groups comprises the PUs on the same column of the CU, and the previously coded units are on an upper side of the CU.

36. The motion prediction method as claimed in claim 33, wherein the target direction is a down-right direction, each of the groups comprises the PUs on the same down-right diagonal line of the CU, and the previously coded units are on an upper-left side of the CU.

37. The motion prediction method as claimed in claim 33, wherein the target direction is a down-left direction, each of the groups comprises the PUs on the same down-left diagonal line of the CU, and the previously coded units are on an upper-right side of the CU.

38. The motion prediction method as claimed in claim 33, wherein the motion prediction method is used in an encoding process for encoding the current picture into a bitstream.

39. The motion prediction method as claimed in claim 33, wherein the motion prediction method is used in a decoding process for decoding the current picture from a bitstream.

40. The motion prediction method as claimed in claim 33, wherein the CU is a leaf CU.
